(19) United States
(12) Patent Application Publication
(10) Pub. No.: US 2014/0268716 A1
(43) Pub. Date: Sep. 18, 2014

(54) SYSTEM FOR THE DISTRIBUTION OF LUMINANCE

(71) Applicants: Scott S. YU, Mil Valley, CA (US); Tom WARTON, Sonoma, CA (US)

(72) Inventors: Scott S. YU, Mil Valley, CA (US); Tom WARTON, Sonoma, CA (US)

(21) Appl. No.: 14/210,160

(22) Filed: Mar. 13, 2014

Related U.S. Application Data
(60) Provisional application No. 61/801,860, filed on Mar. 15, 2013.

(51) Int. Cl. F21V 33/00; F21K 99/00

(52) U.S. Cl. CPC F21V 33/0036; F21K 9/30
USPC 362/217.12; 362/368

(57) ABSTRACT

A sneeze guard, which may include a first and second layer, said layers disposed together and including an integrally formed light rail. The light rail formed to replace, in part, of one layer of the sneeze guard. The light rail may include lamps or LEDs and is disposed for splaying light into a portion of the sneeze guard. In some embodiments a portion of a sneeze guard layer operates to protect the light rail components.

### PRIORITY

This application claims the benefit of co-pending provisional patent application 61/801,860 filed Mar. 15, 2013 entitled “A System For The Distribution Of Luminance” by the same inventors which is incorporated by reference as if fully set forth herein.

### BACKGROUND

The present invention relates generally to a luminaire and more particularly to a modular lighting system, which comprises a plurality of lighting system components, which can be designed in a variety of different ways. With even more particularity to the modification of the distribution of light.

Lighting fixtures are one of the basic lighting devices used in homes, offices and a variety of industrial settings. A typical lighting fixture may be mounted on a wall, at a position above a desk, in a corridor, a door entrance, or a garage door such that the lighting fixture can illuminate the area. There are many factors that control the market for luminaires and lighting systems. A few important factors are the ability to create a well-lit hospitable environment, cost efficiency such as operating cost and other associated costs, code compliance, and more particularly aesthetics. One task that lighting designers have is finding adjustable illumination in accordance with an architectural design. Traditional luminaires when mounted include housing, lamps, circuit boards, connectors, lens and other components. This can create an aesthetics or size constraint issue because of the large size of the luminaires. Additionally lighting designers have the task of positioning luminaires at the correct angle to better illuminate the environment. Typically after mounting a traditional luminaires, the distribution of light is set and cannot or can only be minimally be modified. What is needed to make the environment more aesthetically pleasing is an easy to install, affordable means for attaching a lighting system to a support structure and for modifying the distribution of light after installation.

### SUMMARY

Disclosed herein is a sneeze guard, which may include a first and second layer, said layers disposed together and including an integrally formed light rail. The light rail formed to replace, in part, of one layer of the sneeze guard. The light rail may include lamps or LEDs and is disposed for splaying light into a portion of the sneeze guard. In some embodiments a portion of a sneeze guard layer operates to protect the light rail components.

The construction and method of operation of the invention, however, together with additional objectives and advantages thereof will be best understood from the following description of specific embodiments when read in connection with the accompanying drawings.

### BRIEF DESCRIPTION OF THE DRAWINGS

FIG. 1 depicts one embodiment of a lighting fixture according to aspect of the current disclosure.

FIG. 2 shows a light rail which may be employed in certain embodiments according to the present disclosure.

### DESCRIPTION

Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

Read this application with the following terms and phrases in their most general form. The general meaning of each of these terms or phrases is illustrative, not in any way limiting.

Lexicography

The term “light rail” generally means an elongated fixture for holding a light source such as an LED or lamp. The light rail may include structure for holding the light source in place and in certain embodiments control circuitry and connections for operating the light source.

The term “luminaire” generally refers to a lighting unit consisting of a light source or lamp(s) together with the parts designed to distribute the light, to position and protect the lamps and to connect the lamps to the power supply.

The term “luminance” generally refers to the brightness of a light source or an object that has been illuminated by a source.

Detailed Description

FIG. 1 depicts one embodiment of a mounted lighting fixture 100 according to aspect of the current disclosure. The lighting fixture 100 has a housing 110. This embodiment's housing may be made from aluminum or other suitable material. Typical material includes, but is not limited to plastics, metals, ceramics, and fiberglass or combination thereof. One having skill in the art will appreciate that the housing may be effectuated using other materials to protect the lamp from moisture and other environmental concerns.

The housing 110 is coupled to a guard 114. In certain embodiments the guard 114 may be formed from clear plastic, PLEXIGLAS, glass or other types of material conventionally found in restaurant sneeze guards. While sneeze guards are conventionally clear, this disclosure should not be read to require the guard 114 to be constructed of clear material.

The housing 110 is coupled to a light source 112. In some embodiments light emitting diodes (LEDs) may be employed, however; one having skill in the art will appreciate that the light source may be effectuated using other materials such as one or more fluorescent lamps. The light source 112 may be operated in parallel and then in series to run power through multiple light sources over a large length. The housing 110 may include circuit boards or other substrates for mounting the light source 112 as well as associated electronics for operation of the light source 112.

The light source 112 may be disposed to display light in various directions. In some embodiments the light source may splay light down from the guard 114 on to an area protected by the guard 114. In other embodiments, the light may be directed into an edge of the guard 114 having the affect of edge lighting the guard 114. Certain embodiments may provide for illumination control such that the light source 112 is adjustable using dimming circuitry.

In some embodiments the guard 114 is constructed of several layers including a first shield, a protective shield, and a second shield. The first and second shields may be made from glass or other suitable transparent material that can provide the material strength required to support the luminaire. The protective shield may be made of vinyl or other suitable transparent material that can provide the material strength required to stabilize and strengthen the shields in the event of an adverse impact.

The housing 110 may be formed to replace, in part, a portion of a shield such that the housing 110 is positionally substituted for shielding. By removing a portion of one shield at an edge, the housing 110 may be disposed along the edge providing for a relatively uniform surface and for light from the light source 112 in the housing 110 to be directed through the remaining portion of shield. The shield provides a lens or protective covering for the light source. In some embodiments the housing 110 may be the same thickness as the guard such that the housing 110.

To effectuate certain embodiments the housing 110 may be an elongated L-shape having a shorter dimension at a right angle to a longer dimension and an elongated depth. A light source may be placed into the longer dimension portion which is used in place of a portion of one of the layers. For purposes of this disclosure, the longer dimension including a place for a light source may be referred to as a light rail.

Wiring carrying the power for the light source 112 may be run along a wiring channel (not shown) for power distribution. In operation, after the lighting fixture 100 is installed, the housing 110 and lamp 112 are cleanly mounted thus providing an aesthetically pleasing and small lighting fixture.

References in the specification to “one embodiment”, “an embodiment”, “an example embodiment”, etc., indicate that the embodiment described may include a particular feature, structure or characteristic, but every embodiment may not necessarily include the particular feature, structure or characteristic. Moreover, such phrases are not necessarily referring to the same embodiment. Further, when a particular feature, structure or characteristic is described in connection with an embodiment, it is submitted that it is within the knowledge of one of ordinary skill in the art to effect such feature, structure or characteristic in connection with other embodiments whether or not explicitly described. Parts of the description are presented using terminology commonly employed by those of ordinary skill in the art to convey the substance of their work to others of ordinary skill in the art.

FIG. 2 shows a light rail which may be employed in certain embodiments according to the present disclosure. In FIG. 2 the light rail 210 may include a magnet 212 positioned along the edge of the light rail 210. A magnetically active metal plate 214 may be inserted into a channel 215 of a sneeze guard 216 which is operable to couple with the magnet 212 when the light rail is inserted into the channel 215. In FIG. 2 the light rail 210 includes power and control cables for operating the light rail 210 and the channel 215 may be formed form as part of housing affixed to and end of the sneeze guard 216. In some embodiments the light rail 210 may splay light away from the sneeze guard 216 through an opening in the channel 215 may be optically light and allow for light from the light rail 210 to splay through a portion of the sneeze guard surface 220.

The above illustration provides many different embodiments or embodiments for implementing different features of the invention. Specific embodiments of components and processes are described to help clarify the invention. These are, of course, merely embodiments and are not intended to limit the invention from that described in the claims.

Certain aspects and embodiments of the current disclosure are included in the attached appendix which is incorporated by reference as if fully set forth herein.

Although the invention is illustrated and described herein as embodied in one or more specific examples, it is nevertheless not intended to be limited to the details shown, since various modifications and structural changes may be made therein without departing from the spirit of the invention and within the scope and range of equivalents of the claims. Accordingly, it is appropriate that the appended claims be construed broadly and in a manner consistent with the scope of the invention, as set forth in the following claims.

We claim:

1. A device including:
a housing, said housing including a light source;
a guard, said guard comprising a substantially planar surface with at least one edge,
wherein said housing is disposed along the edge and operates to direct light through a portion of the guard.

2. The device of claim 1 wherein the guard is substantially clear.

3. The device of claim 1 wherein the housing includes a portion substantially the same thickness as the guard.

4. A device comprising:
a sneeze guard, said sneeze guard including at least a first and second layer, said second layer abutting the first layer;
a light rail, said light rail having a edge substantially the same thickness as the sneeze guard and an edge substantially the same width as the first layer;
wherein said light rail is disposed along an edge of the sneeze guard.

5. The device of claim 4 wherein the light rail includes at east one LED light source.

6. The device of claim 4 wherein the sneeze guard comprises a substantially flat portion, said flat portion comprised of substantially clear material.

7. A sneeze guard comprising:
a first substantially planar surface;
a light rail, said light rail disposed over a portion of the surface,
wherein light from the light rail is splayed through a portion of the surface.

8. The sneeze guard of claim 7 wherein the light rail includes one or more light emitting diode.

9. The sneeze guard of claim 7 wherein the light rail is disposed along an edge of the sneeze guard.
